(19) United States
(12) Patent Application Publication
(10) Pub. No.: US 2024/0388679 A1
(43) Pub. Date: Nov. 21, 2024

(54) PROJECTION LIGHT MACHINE

(71) Applicant: Goertek Optical Technology Co., Ltd., Weifang (CN)

(72) Inventors: Rongpeng CUI, Weifang (CN); Qiang Zhang, Weifang (CN); Wengang Gao, Weifang (CN)

(21) Appl. No.: 18/783,893

(22) Filed: Jul. 25, 2024

Related U.S. Application Data
(63) Continuation of application No. PCT/CN2022/101479, filed on Jun. 27, 2022.

(30) Foreign Application Priority Data
May 23, 2022 (CN) 202210565606.4

(51) Int. Cl. H04N 9/31; G03B 21/20

(52) U.S. Cl. CPC H04N 9/3158; G03B 21/208

(57) ABSTRACT

The present application discloses a projection light machine including a body and a prism. The body is provided with a slot and a first positioning surface, and the prism includes a first side edge, a second side edge and a bevel edge connected end to end. The second side edge and the bevel edge are enclosed to form a bevel end, and the first side edge is attached to the first positioning surface. The bevel end is clamped in the slot, and the body is provided with a through hole at a bottom surface of the prism. The through hole is filled with adhesive, and the adhesive is bonded to the prism. The size of the through hole is configured to gradually increase from a side close to the prism to a side away from the prism.

### CROSS-REFERENCE TO RELATED APPLICATIONS

The present application is a continuation application of International Application No. PCT/CN2022/101479, filed on Jun. 27, 2022, which claims priority to Chinese patent application No. 202210565606.4, and filed on May 23, 2022, the entire contents of which are incorporated herein by reference.

### TECHNICAL FIELD

The present application relates to the technical field of projection light machines, and in particular to a projection light machine.

### BACKGROUND

With the development of micro-projection light machine technology, more and more home projection light machines have entered people's view. However, as the lighting time of the projection light machine increases, an inevitable problem, namely, defocus will occur. Specifically, since the internal temperature of the projection light machine rises sharply due to long-term operation, the fixed glue point produces thermal expansion, causing the prism to move from its original position, resulting in defocus of the projected image.

In view of this, it is necessary to provide a new type of projection light machine to solve or at least alleviate the above technical defects.

### SUMMARY

The main purpose of the present application is to provide a projection light machine, aiming to solve the technical problem of defocus of the projection light machine in the related art.

In order to achieve the above objectives, the present application provides a projection light machine including a body and a prism. The body is provided with a slot and a first positioning surface, and the prism includes a first side edge, a second side edge and a bevel edge connected end to end. The second side edge and the bevel edge are enclosed to form a bevel end, and the first side edge is attached to the first positioning surface. The bevel end is clamped in the slot, and the body is provided with a through hole at a bottom surface of the prism. The through hole is filled with adhesive, and the adhesive is bonded to the prism. The size of the through hole is configured to gradually increase from a side close to the prism to a side away from the prism.

In an embodiment, the through hole is a tapered hole.

In an embodiment, a number of the through hole is one.

In an embodiment, the first positioning surface includes at least two sub-positioning surfaces arranged at intervals; one of the two sub-positioning surfaces is attached to the first side edge, and the other of the two sub-positioning surfaces is attached to the first side edge.

In an embodiment, the slot includes a bottom wall, a first sidewall and a second sidewall; the first sidewall is connected to one side of the bottom wall, and the second sidewall is connected to the other side of the bottom wall; a width of the slot is configured to gradually increase from the bottom wall to an opening of the slot, and the first sidewall is attached to the second side edge.

In an embodiment, the second sidewall is parallel to the bevel edge.

In an embodiment, a second positioning surface is provided at the body; the second positioning surface and the first sidewall are provided at a same plane, and the second positioning surface is attached to the second side edge.

In an embodiment, the second positioning surface is provided at one end of the second side surface, and the first sidewall is provided at the other end of the second side surface.

In an embodiment, the prism is a right-angle prism, and the first side edge is perpendicular to the second side edge.

In an embodiment, at least two bosses are provided at the body, and heights of at least two of the bosses are the same.

In the above technical solution, the projection light machine includes a body and a prism. The body is provided with a slot and a first positioning surface, and the prism includes a first side edge, a second side edge and a bevel edge connected end to end. The second side edge and the bevel edge are enclosed to form a bevel end, and the first side edge is attached to the first positioning surface. The bevel end is clamped in the slot, and the body is provided with a through hole at a bottom surface of the prism. The through hole is filled with adhesive, and the adhesive is bonded to the prism. The size of the through hole is configured to gradually increase from a side close to the prism to a side away from the prism. The first positioning surface is configured to position the first side edge of the prism, and the slot is configured to position and fix the prism. In this application, the size of the through hole is nonuniform, with a smaller size at the end close to the prism and a larger size at the end away from the prism. In this way, when the adhesive glue expands upward, it will be subject to a component force of the downward reaction force by the sidewall of the through hole, thereby blocking the expansion of the adhesive glue and offsetting the force on the prism due to the expansion, avoiding the prism from being subjected to the thermal expansion of the adhesive glue and generating a force on the bottom of the prism, so that the displacement of the prism can be avoided and the thermal defocus phenomenon can be eliminated.

### BRIEF DESCRIPTION OF THE DRAWINGS

To more clearly illustrate technical solutions in the embodiments of the present application or the related art, the following will briefly introduce the drawings that need to be used in the description of the embodiments or the related art. Obviously, the drawings in the following description are only some embodiments of the present application. For those skilled in the art, without creative effort, other drawings can be obtained according to the structures shown in these drawings.

FIG. 1 is a schematic diagram of the three-dimensional structure of the projection light machine according to an embodiment of the present application.

FIG. 2 is a schematic diagram of partial structure of the projection light machine according to an embodiment of the present application.

FIG. 3 is an enlarged view of FIG. 2 at position A.

FIG. 4 is a schematic diagram of partial three-dimensional structure of the projection light machine according to an embodiment of the present application (excluding the prism).

FIG. 5 is a top view of FIG. 4.

FIG. 6 is a schematic diagram of the structure of a cylindrical through hole in the related art.

FIG. 7 is a force analysis diagram of the adhesive in the through hole according to an embodiment of the present application.

FIG. 8 is a schematic diagram of the relationship between the dimensions and angles of the through hole according to an embodiment of the present application.

The realization of the objective, functional characteristics, and advantages of the present application are further described with reference to the accompanying drawings.

### DETAILED DESCRIPTION OF THE EMBODIMENTS

The technical solutions of the embodiments of the present application will be described in detail below with reference to the accompanying drawings. It is obvious that the embodiments described are only some rather than all of the embodiments of the present application. All other embodiments obtained by those skilled in the art based on the embodiments of the present application without creative efforts shall fall within the claimed scope of the present application.

It should be noted that all the directional indications (such as up, down . . . ) in the embodiments of the present application are only used to explain the relative positional relationship, movement, or the like of the components in a certain posture (as shown in the accompanying drawings). If the specific posture changes, the directional indication will change accordingly.

Besides, the descriptions associated with, e.g. “first” and “second,” in the present application are merely for descriptive purposes, and cannot be understood as indicating or suggesting relative importance or impliedly indicating the number of the indicated technical feature. Therefore, the feature associated with “first” or “second” can expressly or impliedly include at least one such feature.

In addition, the technical solutions of the various embodiments can be combined with each other, but the combinations must be based on the realization of those skilled in the art. When the combination of technical solutions is contradictory or cannot be achieved, it should be considered that such a combination of technical solutions does not exist, nor does it fall within the scope of the present application.

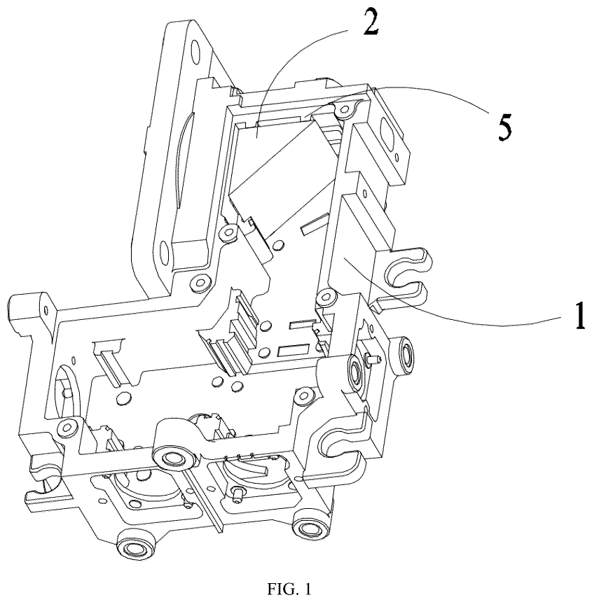

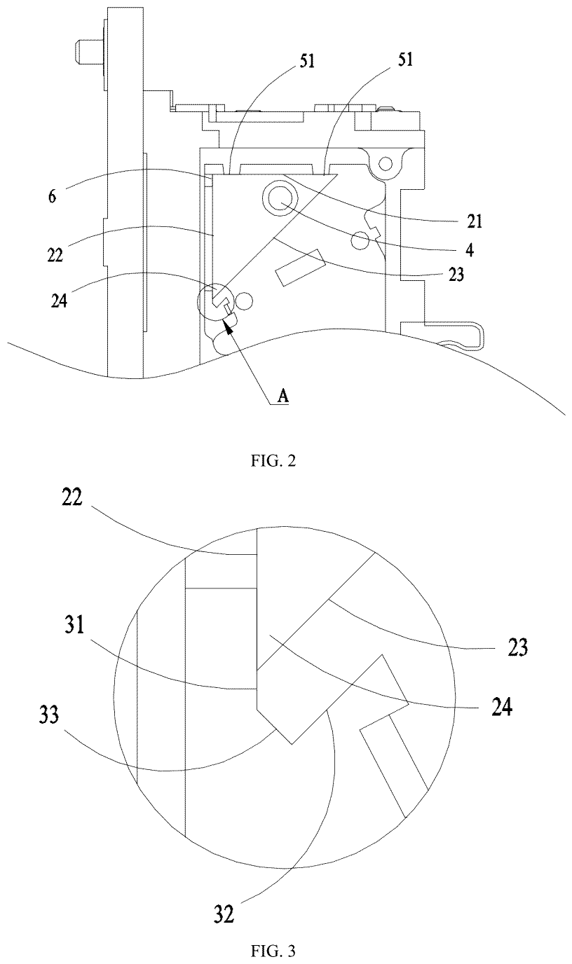

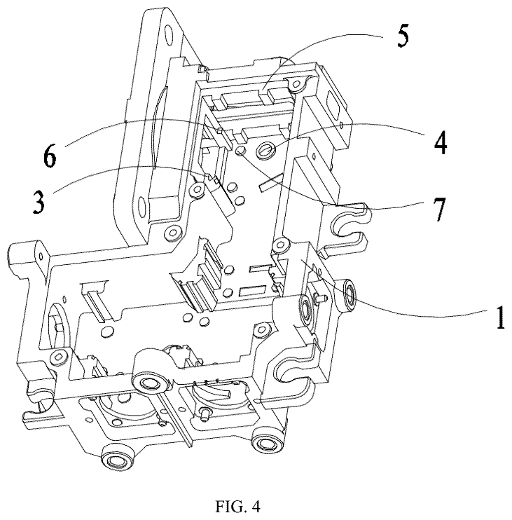

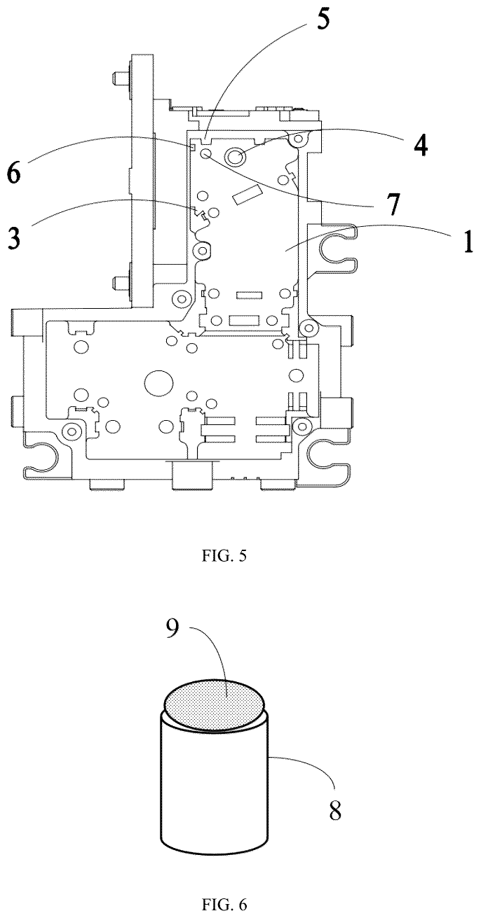

As shown in FIG. 1 to FIG. 5, in order to show the relative position of the through hole 4 and the prism 2, FIG. 2 shows the position of the through hole 4 located at the bottom of the prism 2. The present application provides a projection light machine including a body 1 and a prism 2. The body 1 is provided with a slot 3 and a first positioning surface 5. The prism 2 includes a first side edge 21, a second side edge 22 and a bevel edge 23 connected end to end. The second side edge 22 and the bevel edge 23 are enclosed to form a bevel end 24. The first side edge 21 is attached to the first positioning surface 5. The bevel end 24 is clamped in the slot 3. The body 1 is provided with a through hole 4 at the bottom surface of the prism 2. The through hole 4 is filled with adhesive 9. The adhesive 9 is bonded to the prism 2, and the size of the through hole 4 gradually increases from the side close to the prism 2 to the side away from the prism 2.

It should be noted that in the related art, as shown in FIG. 6, the through hole is generally a cylindrical hole 8, and the adhesive 9 is filled in the cylindrical hole 8. When the temperature of the body 1 of the projection light machine rises, the movement of the heated molecules in the glue molecules accelerates, which is manifested in the macroscopic form of an increase in the volume and temperature of the glue. Since the adhesive glue 9 is limited in the radial direction of the cylinder, the height increases in the vertical direction, exerting a force on the bottom surface of the prism 2, causing the prism 2 to move, thereby causing the optical projection to change and form thermal defocus.

In the above embodiment of the present application, the first positioning surface 5 is configured to position the first side edge 21 of the prism 2, and the slot 3 is configured to position and fix the prism 2. In this embodiment, the size of the through hole 4 is nonuniform, with a smaller size at the end close to the prism 2 and a larger size at the end away from the prism 2. In this way, when the adhesive glue 9 expands upward, it will be subject to a component force of the downward reaction force by the sidewall of the through hole 4, thereby blocking the expansion of the adhesive glue 9 and offsetting the force on the prism 2 due to the expansion, avoiding the prism 2 from being subjected to the thermal expansion of the adhesive glue 9 and generating a force on the bottom of the prism 2, so that the displacement of the prism 2 can be avoided and the thermal defocus phenomenon can be eliminated.

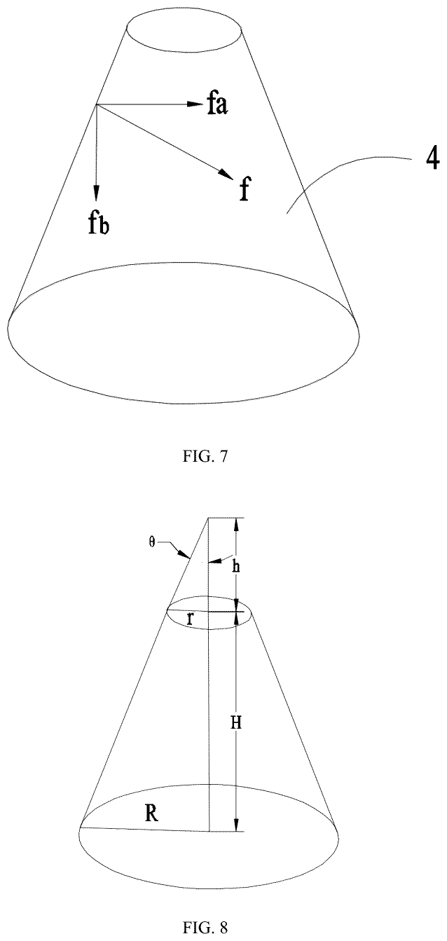

In order to more clearly explain the force exerted on the adhesive 9 in the through hole 4, as shown in FIG. 7, when the through hole 4 is a tapered hole, the force model of the adhesive 9 on the inner wall of the through hole 4 due to expansion of the adhesive 9 can be equivalent to the force analysis of the contact surface microelement in the vertical and horizontal directions. That is, according to the relationship between the action force and the reaction force, the reaction force exerted by the inner wall of the through hole 4 on the adhesive is f. In the vertical direction, the adhesive 9 exerts a vertical upward force on the inner wall, and the reaction force f can be decomposed into a vertical downward force fb. In the horizontal direction, the adhesive 9 exerts a force outward along the radius on the inner wall, and the reaction force f can be decomposed into an inward force fa exerted by the inner wall on the adhesive. It can be understood by those skilled in the art that f is the combined force of fa and fb. From the above analysis, it can be seen that the sidewall of the through hole 4 offsets the vertical upward force of the adhesive 9, which further offsets the original force exerted by the adhesive 9 on the prism 2. Therefore, it can ensure that the prism 2 does not move, which plays a role in eliminating the thermal defocusing phenomenon. The adhesive 9 may be the photosensitive adhesive. The prism 2 may be a right-angle prism 2, and the first side edge 21 may be perpendicular to the second side edge 22.

In one embodiment, the through hole 4 is a tapered hole. It should be noted that the present application does not specifically limit the shape of the through hole 4, as long as the design of the sidewall structure of the through hole 4 can generate a force on the adhesive 9 that deviates from the prism 2, offsetting or reducing the force due to expansion of the adhesive 9 on the prism. For example, the shape of the through hole 4 may further be a cubic structure with a rectangular cross section or a square cross section with varying sizes, or can be a trumpet-shaped structure, or other irregular structures. The inner wall of the through hole 4 may form a serrated shape to increase the blocking effect of the sidewall on expansion of the adhesive 9. In an embodiment, the through hole 4 is a tapered hole, which is more convenient to process. As shown in FIG. 8, R is the radius of the lower circle, and r is the radius of the upper circle. H be the thickness of the bottom body of the light machine (or the height of the through hole 4), and h be the virtual height. θ is the angle between the bevel edge 23 and the vertical direction. The size of θ is related to the radius of the lower circle of the through hole 4 and the radius of the upper circle of the through hole 4, and the trigonometric function relationship can be obtained by following formula.

INCLUDEPICTURE\d“https://patentimages.storage.googleapis.com/de/97/70/aac548619d0b29/PCTCN2022101479-appb-000001.png”\*MERGEFORMATINET

In addition, it can be seen from the above formula that, if R and H are constant, tan θ and r are in the inversely proportional relationship. Combined with the above analysis, the smaller r is, the larger tan θ is, and the larger fb is. The inner wall of the through hole 4 bears a greater force on the prism 2 caused by the thermal expansion of the glue point, thereby reducing the displacement of the prism 2. In fact, the radius of the lower circle of the through hole 4 and the radius of the upper circle of the through hole 4 are set according to the size of the prism 2 and the thickness of the light machine body 1. Any small circle radius, large circle radius or θ designed by using the technical concept of the present application shall fall within the scope of the present application.

In one embodiment, the number of through holes 4 is one. Since the temperature distribution in the light machine body is uneven, the arrangement of multiple through holes 4 will cause different expansion degrees of adhesive at different positions, causing the prism 2 to move. Of course, two or more through holes 4 can be set as needed.

In one embodiment, the first positioning surface 5 includes at least two sub-positioning surfaces 51 arranged at intervals, and the two sub-positioning surfaces 51 are respectively attached to the first side edge 21. The first positioning surface 5 can be a whole plane, or it can include sub-positioning surfaces 51 arranged at intervals. Each sub-positioning surface 51 is located on the same plane, and each sub-positioning surface 51 is attached to the first side edge 21 to play a positioning role.

In one embodiment, the slot 3 includes a bottom wall 33, a first sidewall 31 and a second sidewall 32 respectively connected to both sides of the bottom wall 33. The width of the slot 3 gradually increases from the bottom wall 33 of the slot 3 to an opening of the slot 3, and the first sidewall 31 is attached to the second side edge 22. The slot 3 is configured to fix the prism 2, and there is a small gap between the slot 3 with the bevel end 24 of the prism 2 for easy installation. To ensure tight installation, the first sidewall 31 of the slot 3 is attached to the second side edge 22 of the prism 2 to ensure that the prism 2 does not move. Of course, the attachment mentioned here only means that the first sidewall 31 is attached to part of the second side edge 22 that is located at the bevel end 24, not the first sidewall 31 is attached to the whole second side edge 22. In an embodiment, the second sidewall 32 is parallel to the bevel 23.

In an embodiment, a second positioning surface 6 is further provided at the body 1. The second positioning surface 6 and the first sidewall 31 are located on the same plane, and the second positioning surface 6 is attached to the second side edge 22. The second positioning surface 6 further plays a positioning role. The second positioning surface 6 and the first sidewall 31 are located in the same plane to ensure that the second positioning surface 6 can be attached to the second side edge 22 like the first sidewall 31, so as to play a good positioning role. The second positioning surface 6 and the first sidewall 31 are located at both ends of the second side edge, and the second side edge 22 is positioned from both ends to avoid the second side edge 22 being moved due to force on one end. The flatness of the first positioning surface 5 and the second positioning surface 6 is controlled at 0.01±0.005 mm.

In one embodiment, at least two bosses 7 are further provided at the body 1, and at least two bosses 7 have the same height. The bosses 7 are used for positioning and supporting, and at least two bosses 7 have the same height to ensure that the bottom surface of the prism 2 is placed in parallel, and the flatness of the boss 7 surface is controlled at 0.01±0.005 mm.

The above are only some embodiments of the present application, and do not limit the scope of the present application thereto. Under the concept of the present application, any equivalent structural transformation made according to the description and drawings of the present application, or direct/indirect application in other related technical fields shall fall within the claimed scope of the present application.

What is claimed is:

1. A projection light machine, comprising:
a body; and
a prism;
wherein the body is provided with a slot and a first positioning surface, and the prism comprises a first side edge, a second side edge and a bevel edge connected end to end;
the second side edge and the bevel edge are enclosed to form a bevel end, and the first side edge is attached to the first positioning surface;
the bevel end is clamped in the slot, and the body is provided with a through hole at a bottom surface of the prism;
the through hole is filled with adhesive, and the adhesive is bonded to the prism; and
a size of the through hole is configured to gradually increase from a side close to the prism to a side away from the prism.

2. The projection light machine according to claim 1, wherein the through hole is a tapered hole.

3. The projection light machine according to claim 1, wherein a number of the through hole is one.

4. The projection light machine according to claim 1, wherein the first positioning surface comprises at least two sub-positioning surfaces arranged at intervals; one of the two sub-positioning surfaces is attached to the first side edge, and the other of the two sub-positioning surfaces is attached to the first side edge.

5. The projection light machine according to claim 1, wherein the slot comprises a bottom wall, a first sidewall and a second sidewall; the first sidewall is connected to one side of the bottom wall, and the second sidewall is connected to the other side of the bottom wall; a width of the slot is configured to gradually increase from the bottom wall to an opening of the slot, and the first sidewall is attached to the second side edge.

6. The projection light machine according to claim 5, wherein the second sidewall is parallel to the bevel edge.

7. The projection light machine according to claim 5, wherein a second positioning surface is provided at the body; the second positioning surface and the first sidewall are provided at a same plane, and the second positioning surface is attached to the second side edge.

8. The projection light machine according to claim 7, wherein the second positioning surface is provided at one end of the second side surface, and the first sidewall is provided at the other end of the second side surface.

9. The projection light machine according to claim 1, wherein the prism is a right-angle prism, and the first side edge is perpendicular to the second side edge.

10. The projection light machine according to claim 1, wherein at least two bosses are provided at the body, and heights of at least two of the bosses are the same.
